(19) United States
(12) Patent Application Publication
(10) Pub. No.: US 2008/0218477 A1
(43) Pub. Date: Sep. 11, 2008

(54) Computer mouse

(75) Inventor: Yen-Liang Kuan, Sijhih City (TW)

Correspondence Address: Joe McKinney Muncy, PO Box 1364, Fairfax, VA, 22038-1364, US

(73) Assignee: Behavior Tech Computer Corp.

(21) Appl. No.: 11/797,465

(22) Filed: May 3, 2007

(30) Foreign Application Priority Data
Mar. 9, 2007 (TW) 96203884

(51) Int. Cl. G06F 3/033

(52) U.S. Cl. 345/163

(57) ABSTRACT

A computer mouse is described. The main body has a base part and a movable part. The movable part is slidingly connected with the base part and the movable part slides along a plane that is parallel to the base part. A cover is pivotally connected with the main body by end portions thereof such that the cover is swiveled relative to the main body. An inner wall of the cover has a convex surface. When the movable part is in contact with the convex surface, unconnected end portions of the main body and the cover form a greater height than the pivotally connected end portions of the main body and the cover do.

### RELATED APPLICATIONS

This application claims priority to Taiwan Application Serial Number 96203884, filed Mar. 9, 2007, which is herein incorporated by reference.

### BACKGROUND

1. Field of Invention

The present invention relates to a pointing device. More particularly, the present invention relates to a computer mouse.

2. Description of Related Art

A computer mouse is one of pointing devices to input spatial data, i.e. continuous and multi-dimensional data, to a computer. As a computers becomes smaller and thinner, the computer mouse also becomes smaller and thinner for portability. Although a small and thin computer mouse is easily carried around, a bigger hand, i.e. a guy's hand, may not easily grasp the computer mouse. How to handle above problem needs more efforts devoted by various manufacturers.

### SUMMARY

A computer mouse comprises a main body and a cover. The main body has a base part and a movable part. The movable part is slidingly connected with the base part and the movable part slides along a plane that is parallel to the base part. A cover is pivotally connected with the main body by end portions thereof such that the cover is swiveled relative to the main body. An inner wall of the cover has a convex surface. When the movable part is in contact with the convex surface, unconnected end portions of the main body and the cover form a greater height than the pivotally connected end portions of the main body and the cover do.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a computer mouse according to one embodiment of this invention;

FIG. 2 illustrates a different configuration of the computer mouse in FIG. 1;

FIG. 3 illustrates another configuration of the computer mouse in FIG. 1;

FIG. 4 illustrates a top view of the computer mouse in FIG. 1;

FIG. 5 illustrates a top view of the computer mouse in FIG. 2;

FIG. 6 illustrates a series of configurations of a computer mouse according to another embodiment of this invention;

FIG. 7 illustrates a bottom view of the computer mouse in FIG. 6;

FIG. 8 illustrates a computer mouse according to yet another embodiment of this invention;

FIG. 9 illustrates a different configuration of the computer mouse in FIG. 8;

FIG. 10 illustrates a side view of the computer mouse in FIG. 8; and

FIG. 11 illustrates a side view of the computer mouse in FIG. 9.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In the following embodiments of the invention, a computer mouse with a height-adjustable function is illustrated. As the computer mouse serves as a pointing device to input spatial data to a computer, a greater height (or thickness) is desired to be easily grasped by a hand. As the computer mouse performs other functions, a thinner height (or thickness) is preferred.

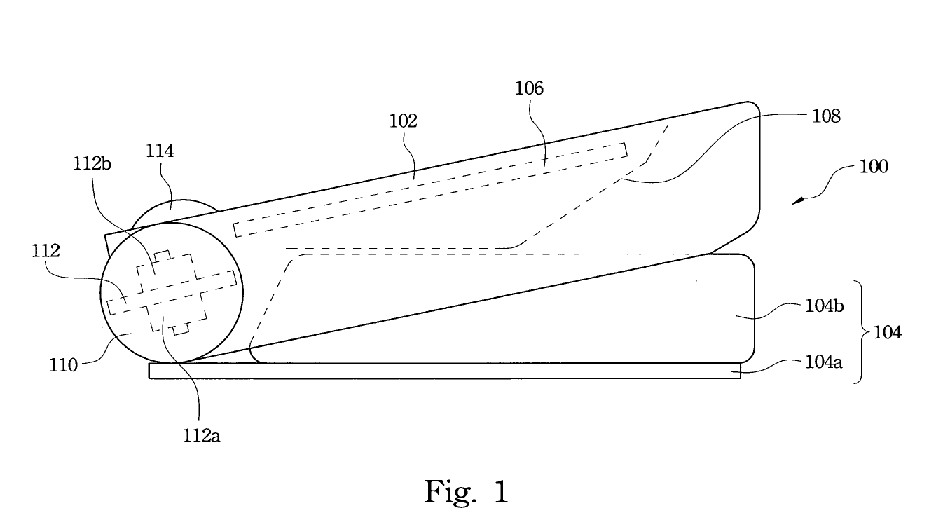

FIG. 1 illustrates a computer mouse according to one embodiment of this invention. The computer mouse 100 includes a main body 104 and a cover 102. An end portion of the cover 102 is pivotally connected with an end portion of the main body 104 by a hinge 110 such that the cover 102 is capable of being swiveled to a desired position relative to the main body 104. The main body 104 further includes a movable part 104b and a base part 104a. The movable part 104b is slidingly connected with the base part 104a, and the movable part 104b slides along a plane that is parallel to the base part 104a. The cover 102 has a convex surface 108 on an inner wall thereof. When the movable part 104b is in contact with the convex surface 108 of the cover 102, unconnected end portions of the main body 104 and the cover 102 form a greater height than the pivotally connected end portions (hinge 110) of the main body 104 and the cover 102 do. As the computer mouse 100 is adjusted to a greater height, it is easily grasped by a hand to input spatial data to a computer.

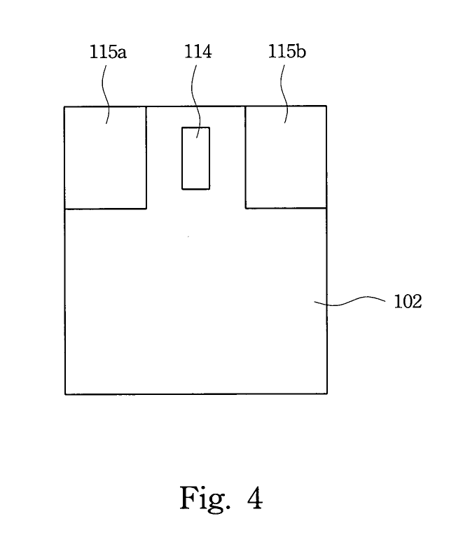

Please refer to FIG. 1 and FIG. 4. A circuit board 106 is disposed inside the cover 102, and another circuit board 112 is disposed inside the hinge 110. The circuit board can also be disposed inside the base part 104a of the main body 104. A right button 115b, a left button 115a and a scroll wheel 114 are disposed near the hinge 110. A switch 112b can be installed on the circuit board 112 to be actuated by the right button 115b and/or the left button 115a. Besides, an optical sensor 112a can be installed on the circuit board 112 to sense position changes (of the computer mouse 100) and input spatial data to a computer.

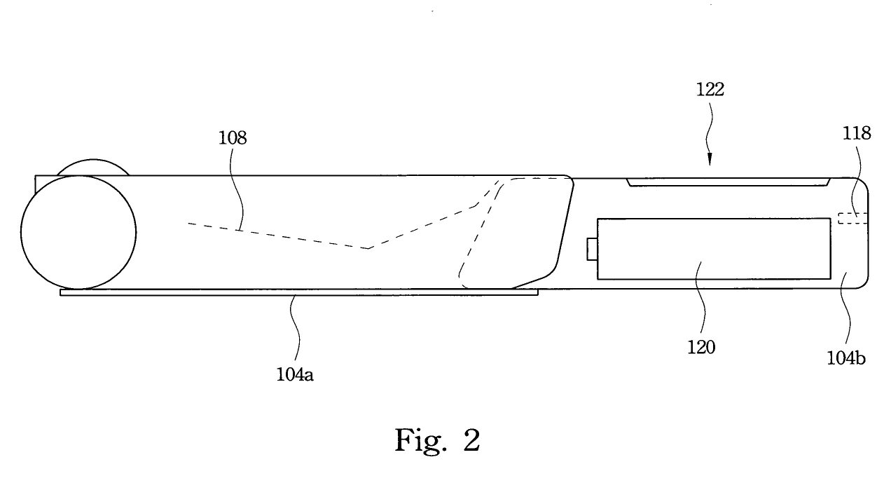

FIG. 2 illustrates a different configuration of the computer mouse in FIG. 1. As the movable part 104b is slidingly connected with the base part 104a, the movable part 104b can be slid out of the cover 102 (not shielded by the cover 102). When the movable part 104b slides to a position where the movable part 104b is not in contact with the convex surface 108, the unconnected end portions of the main body 104 and the cover 104 roughly form the same height as the pivotally connected end portions (hinge 110) of the main body 104 and the cover 102 do. The computer mouse 100 is thus adjusted to a smaller height to be easily carried or perform other functions.

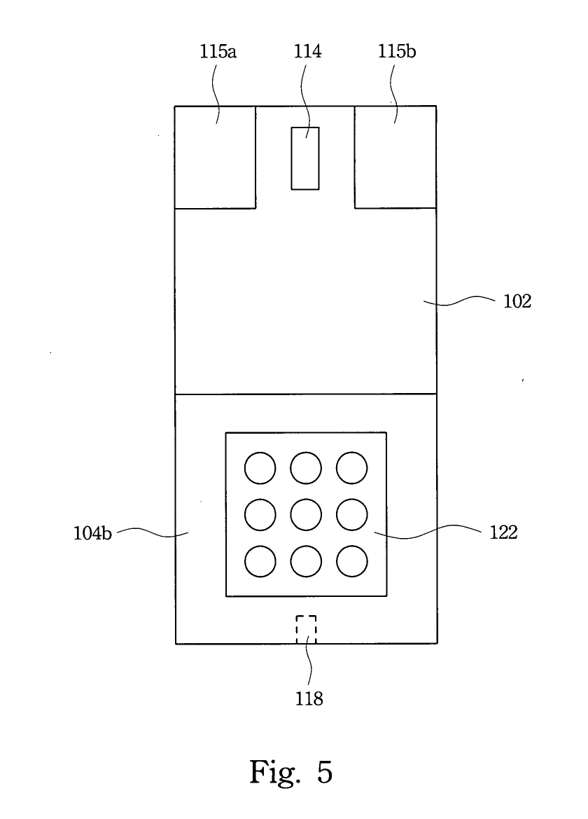

Please refer to FIG. 2 and FIG. 5. The movable part 104b may include a battery 120, a keypad section 122 (with multiple keys) and an LED 118 to perform extra functions, i.e. a laser pointer or a remote controller, other than inputting spatial data to a computer. The battery 120 supplies power to components which consume power. The keypad section 122 is to control the laser pointer or the remote controller by pressing keys, and control signals or visible lasers are emitted from the LED 118.

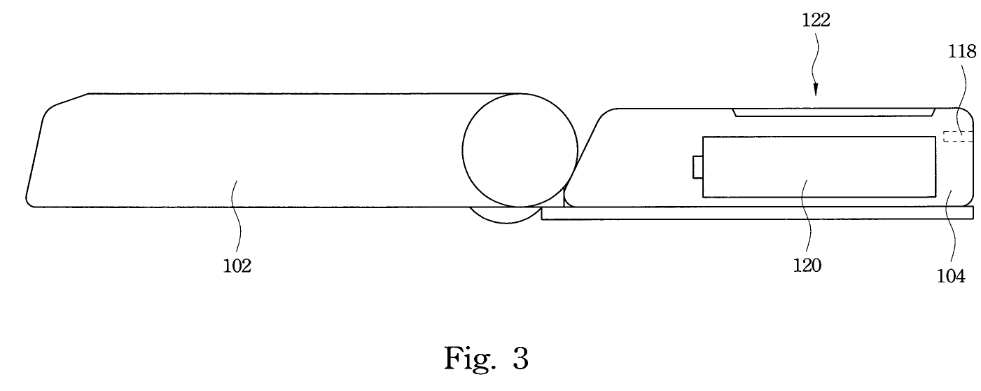

FIG. 3 illustrates another configuration of the computer mouse in FIG. 1. In this embodiment, another way is provided to adjust the height of the computer mouse 100. In particular, the cover 102 is swiveled until the cover 102 and the main body 104 together reach a longest length, the main body 104 roughly has the same thickness as the cover 102 does, and the computer mouse 100 obtains a thinner height (compared to the configuration of the computer mouse 100 in FIG. 1). When the computer mouse 100 exposes its keypad section 122 (as illustrated in FIG. 2 or FIG. 3), a thinner height obtained (compared to FIG. 1), and the computer mouse 100 can serve as a laser pointer or a remote controller.

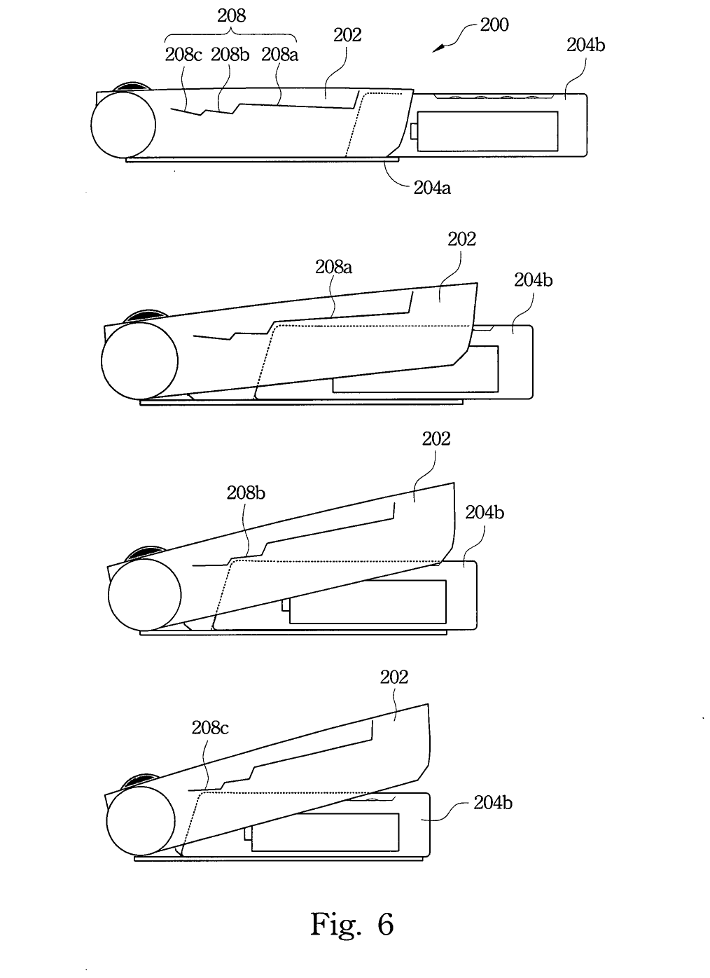

FIG. 6 illustrates a series of configurations of a computer mouse 200 according to another embodiment of this invention. An inner wall of the cover 202 has a convex surface 208 of a staircase structure with multiple step surfaces. The convex surface 208 includes a series of step surfaces 208a/208b/208c. When the movable part 204b is in contact with one of the step surfaces 208a/208b/208c, the computer mouse 200 obtains a different height. For instances, when the movable part 204b is in contact with the step surface 208a, the cover 202 is swiveled by 5 degrees. When the movable part 204b is in contact with the step surface 208b, the cover 202 is swiveled by 10 degrees. When the movable part 204b is in contact with the step surface 208c, the cover 202 is swiveled by 15 degrees.

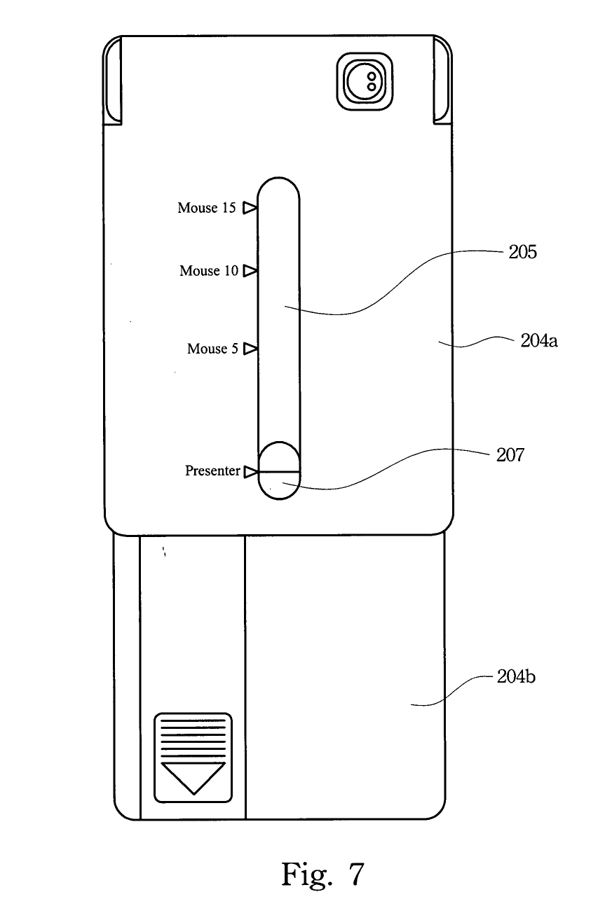

FIG. 7 illustrates a bottom view of the computer mouse in FIG. 6. A connection portion 207 of the movable part 204b engages within a slot 205 of the base part 204a such that the movable part 204b can slide relative to the base part 204a. Indicators, i.e. Mouse 5, Mouse 10, Mouse 15 and Presenter, can be marked around the slot 205 to be easily recognized by users where the movable part 204b can be slid to get a desired height (or a desired swiveled angle of the cover 202). The slot 205 location is not limited in a central area of the base part 204a.

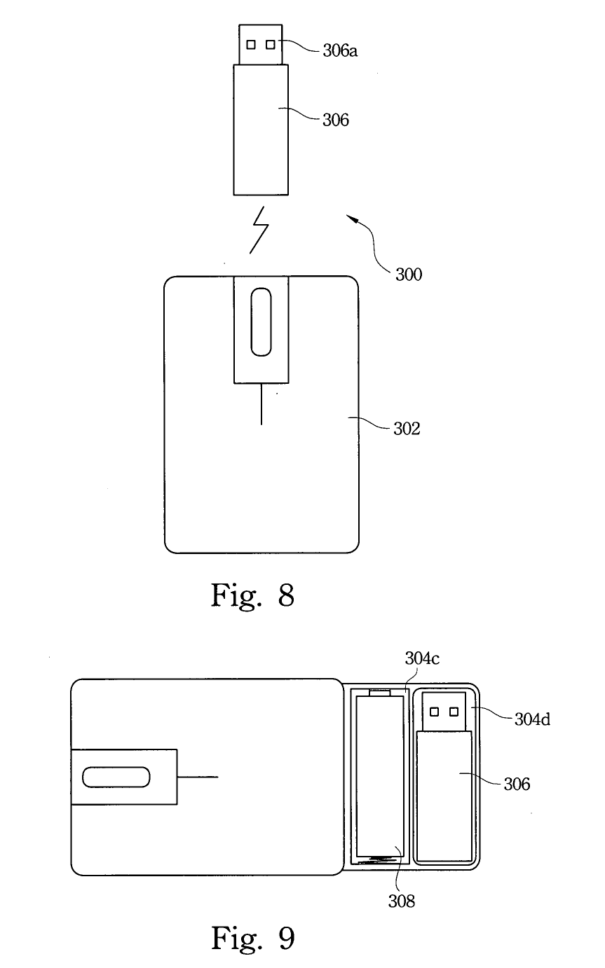

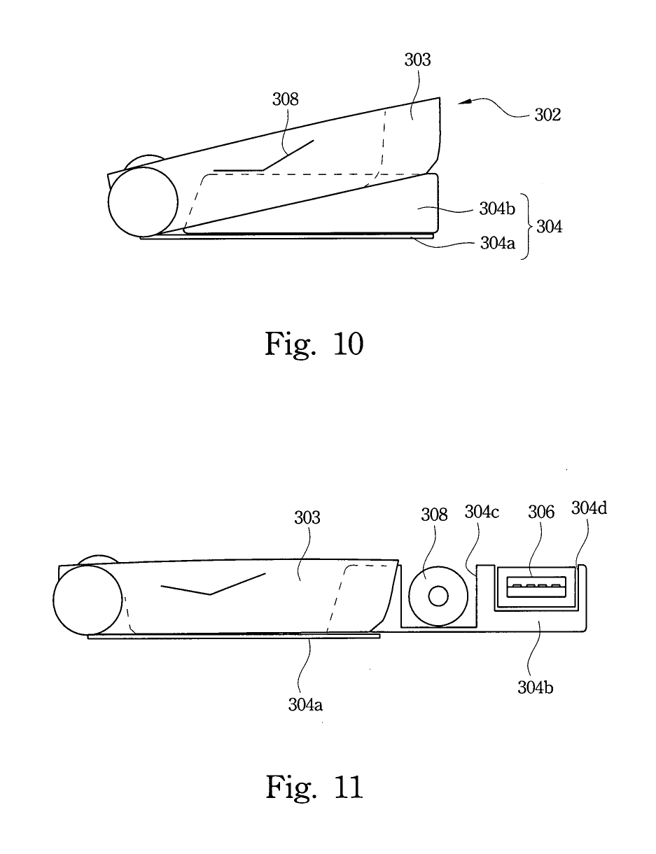

FIG. 8 illustrates a computer mouse according to yet another embodiment of this invention. FIG. 10 illustrates a side view of the computer mouse in FIG. 8. This embodiment illustrates a wireless computer mouse 300 with a height-adjustable function. The computer mouse 300 includes a mouse body 302 and a wireless transceiver 306. The wireless transceiver 306 has a connector 306a to be inserted into a corresponding connection port of a computer (not illustrated). Thus, the mouse body 302 can be coupled to the computer via the wireless transceiver 306, thereby inputting spatial data.

FIG. 10 illustrates a side view of the computer mouse in FIG. 8. When the computer mouse 300 serves its basic function (inputting spatial data), the mouse body 302 is adjusted up to greater height to be easily grasped by a hand. The mouse body 302 includes a main body 304 and a cover 303. An end portion of the cover 303 is pivotally connected with an end portion of the main body 304 by a hinge. The height adjusting way is similar to the embodiment in FIG. 1. When a movable part 304b is in contact with a convex surface 308, the mouse body 302 obtains a greater height.

Please refer to FIG. 9 and FIG. 11. The main body 304 includes a concave portion 304c and a concave portion 304d. The concave portion 304c is to accommodate a battery 308. The concave portion 304d is to accommodate the wireless transceiver 306. The movable part 304b slides relative to a base part 304a. When the movable part 304b is pulled out of the mouse body 302, the battery 308 can be put in or taken out of the concave portion 304c, and the wireless transceiver 306 can be put in or taken out of the concave portion 304d.

According to embodiments discussed above, the present invention provides a computer mouse with a height-adjustable function. When the computer mouse serves as a pointing device to input spatial data to a computer, a greater height (or thickness) is desired to be easily grasped by a hand. As the computer mouse performs other functions, a thinner height is preferred.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer mouse, comprising:
a main body, having a base part and a movable part, wherein the movable part is slidingly connected with the base part; and
a cover, pivotally connected with the main body by end portions thereof such that the cover is swiveled relative to the main body, wherein an inner wall of the cover having a convex surface,
when the movable part is in contact with the convex surface, unconnected end portions of the main body and the cover form a greater height than the pivotally connected end portions of the main body and the cover do.

2. The computer mouse of claim 1, wherein the cover has a right button, a left button and a scroll wheel.

3. The computer mouse of claim 1, wherein the movable part has a keypad section.

4. The computer mouse of claim 1, wherein the movable part has an LED.

5. The computer mouse of claim 1, wherein the movable part has a battery.

6. The computer mouse of claim 1, wherein the convex surface is a staircase structure of multiple step surfaces.

7. A computer mouse, comprising:
a main body, having a base part and a movable part, wherein the movable part is slidingly connected with the base part; and
a cover, pivotally connected with the main body by end portions thereof such that the cover is swiveled relative to the main body, wherein an inner wall of the cover having a convex surface,
when the movable part is in contact with the convex surface, unconnected end portions of the main body and the cover form a greater height than the pivotally connected end portions of the main body and the cover do,
when the movable part is not in contact with the convex surface, the unconnected end portions of the main body and the cover roughly form the same height as the pivotally connected end portions of the main body and the cover do.

8. The computer mouse of claim 7, wherein the cover has a right button, a left button and a scroll wheel.

9. The computer mouse of claim 7, wherein the movable part has a keypad section.

10. The computer mouse of claim 7, wherein the movable part has an LED.

11. The computer mouse of claim 7, wherein the movable part has a battery.

12. The computer mouse of claim 7, wherein the convex surface is a staircase structure of multiple step surfaces.

13. The computer mouse of claim 1, further comprising a wireless transceiver, wherein the wireless transceiver comprises a connector to be inserted into a corresponding connection port of a computer.

14. The computer mouse of claim 13, wherein the movable part has a concave portion for accommodating the wireless transceiver.

15. A computer mouse, comprising:
a main body, having a base part and a movable part, wherein the movable part is slidingly connected with the base part; and
a cover, pivotally connected with the main body by end portions thereof such that the cover is swiveled relative to the main body, wherein an inner wall of the cover having a convex surface,
when the movable part is in contact with the convex surface, unconnected end portions of the main body and the cover form a greater height than the pivotally connected end portions of the main body and the cover do,
when the movable part is not in contact with the convex surface, the unconnected end portions of the main body and the cover roughly form the same height as the pivotally connected end portions of the main body and the cover do,
when the movable part is swiveled to a position where the movable part and the main body together form a longest length, the main body roughly has the same thickness as the cover does.

16. The computer mouse of claim 15, wherein the cover has a right button, a left button and a scroll wheel.

17. The computer mouse of claim 15, wherein the movable part has a keypad section.

18. The computer mouse of claim 15, wherein the movable part has an LED.

19. The computer mouse of claim 15, wherein the movable part has a battery.

20. The computer mouse of claim 15, wherein the convex surface is a staircase structure of multiple step surfaces.
